(19) United States
(12) Patent Application Publication
(10) Pub. No.: US 2025/0361813 A1
(43) Pub. Date: Nov. 27, 2025

(54) BLADE WITH COMPOSITE STRUCTURE HAVING IMPROVED PLY DROP ORIENTATION

(71) Applicant: Safran Aircraft Engines, PARIS (FR)

(72) Inventors: Guillaume Pascal Jean-Charles GONDRE, MOISSY-CRAMAYEL (FR); Alain Jacques Michel BASSOT, MOISSY-CRAMAYEL (FR)

(73) Assignee: Safran Aircraft Engines, PARIS (FR)

(21) Appl. No.: 18/875,062

(22) PCT Filed: Jun. 16, 2023
(86) PCT No.: PCT/FR2023/050881

§ 371 Date: Dec. 13, 2024

(30) Foreign Application Priority Data
Jun. 16, 2022 (FR) FR2205896

(51) Int. Cl. F01D 5/28; F01D 5/14

(52) U.S. Cl. CPC F01D 5/28; F01D 5/14; F05D 2220/36; F05D 2300/603

(57) ABSTRACT

The disclosed fan blade is composed at least in part of a structure (50) made of composite material comprising a fiber reinforcement and a matrix. The fiber reinforcement includes a plurality of plies that are each formed of warp yarns and weft yarns. The warp yarns and weft yarns include incomplete yarns that each have a terminal end on the pressure side (40) or the suction side. The pressure side (40) and the suction side each have at least one ply drop line (80, 81) connecting the terminal ends of the incomplete yarns of the same ply. At least one ply drop line (81) has an end portion (96) that extends from the blade tip up to 90% of the blade height. Said end portion (96) extends generally along a direction of extent (E) forming an angle between 5° and 85° with the local tangent of the warp yarns.

### FIELD OF THE INVENTION

The present invention relates to a turbomachine fan blade, of the type comprising a root configured to be inserted in a cell of a fan disc, an aerofoil able to extend in an air flow and defining a blade tip opposite the root, and a stilt connecting the root to the aerofoil, the blade having a pressure side, a suction side, a leading edge and a trailing edge, the blade being elongated in a longitudinal direction going from the root to the blade tip, said longitudinal direction being substantially orthogonal to a chord direction going from the leading edge to the trailing edge, the blade being composed at least in part of a structure made of composite material comprising a fibrous reinforcement obtained by three-dimensional weaving and a matrix in which the fibrous reinforcement is embedded, the fibrous reinforcement comprising a plurality of interwoven plies, each ply being formed of warp strands extending substantially orthogonally to the chord direction and weft strands extending substantially orthogonally to the longitudinal direction, the warp strands and the weft strands including incomplete strands each having a terminal end on the pressure side or on the suction side, the pressure side and the suction side each having at least one ply drop line each connecting the terminal ends of the incomplete strands of a same ply.

The invention also relates to a turbomachine fan comprising a plurality of blades of the above-mentioned type, a turbomachine comprising such a fan, and an aircraft comprising such a turbomachine.

### TECHNICAL BACKGROUND

Turbomachine blades, and in particular fan blades, are subject to significant mechanical and thermal stresses and must satisfy strict weight and size conditions. It has therefore been proposed to use blades composed, at least in part, of a structure made of composite material comprising a fibrous reinforcement densified by a polymer matrix, which are lighter compared with metal blades with equivalent propulsive characteristics and which have a satisfactory heat resistance.

Such blades are known, for example, from EP 1 526 285.

Most often, the blades have a thickness that decreases going from the stilt to the blade tip. They also taper towards the leading edge and towards the trailing edge. In order to obtain this decreasing thickness with a blade composed of a structure made of composite material, the number of plies composing said structure is generally reduced as the blade tip, the leading edge and the trailing edge are approached. To achieve this, the strands forming these plies are dropped from the structure and interrupted along ply drop lines on the pressure side or on the suction side, as described for example in EP 3 292 991.

During the life of an engine, the fan blades are subjected to impacts with birds and with hailstones. The regulations for aircraft engine certification therefore logically require a certain resistance of the fan blades to this type of impacts. However, the resistance of composite structure blades to such impacts tends to differ from that of their metal equivalents. In order to meet the certification regulations, composite structure blades are therefore often thicker, which can make the design more complex in order to manage the aerodynamic performance of the blade and could partially neutralise the weight saving resulting from the use of composite material.

Solutions have been proposed, for example in EP 3 292 991, WO 2020/089345 and FR 3 087 711, to solve this type of problem and to improve the mechanical behaviour of composite structure blades faced with such impacts. These solutions can be satisfactory but can also merit optimisation.

### DISCLOSURE OF THE INVENTION

An objective of the invention is to improve the mechanical behaviour of composite structure blades in the event of impacts with birds or with hailstones.

For this purpose, an object of the invention, according to a first aspect, is a turbomachine fan blade of the above-mentioned type, wherein at least one ply drop line comprises a terminal portion which extends from the blade tip to 90% of the blade height, advantageously to 60% of the blade height, the or each terminal portion extending overall in an extension direction forming an angle of between 5° and 85° with the local tangent to the warp strands.

According to particular embodiments of the invention, the blade also has one or more of the following features, taken alone or in any technically possible combination:
for the or each terminal portion, the extension direction forms an angle of between 5° and 85° with the local tangent to the weft strands;
at least one terminal portion is constituted by an inclined terminal portion, the extension direction of which forms an angle between 10° and 65°, advantageously between 15° and 45°, with the local tangent to the warp strands;
for the or each inclined terminal portion, the extension direction forms an angle between 25° and 80°, advantageously between 45° and 75°, with the local tangent to the weft strands;
a majority of the terminal portions are constituted by inclined terminal portions;
the blade comprises an attached shield covering the composite structure along of the leading edge, the shield having a downstream edge on the pressure side and a downstream edge on the suction side, the or each terminal portion on the pressure side fulfilling at least one of the following criteria at each of its points:
   the terminal portion is spaced apart from the downstream edge on the pressure side by a distance greater than or equal to three times the mesh width of the fibrous reinforcement, and
   the tangent to the terminal portion forms an angle greater than or equal to 5°, advantageously greater than or equal to 15°, with the tangent to the downstream edge on the pressure side at the height of said point,
and the or each terminal portion on the suction side fulfilling at least one of the following criteria at each of its points:
   the terminal portion is spaced apart from the downstream edge on the suction side by a distance greater than or equal to three times the mesh width of the fibrous reinforcement, and
   the tangent to the terminal portion forms an angle greater than or equal to 5°, advantageously greater than or equal to 15°, with the tangent to the downstream edge on the suction side at the height of said point,
at least one ply drop line includes at least one transverse portion situated between the root and 70% of the blade height, including an apex portion, the or each transverse portion extending overall in a transverse direction substantially orthogonal to the local tangent to the warp strands, the or each apex portion extending over at most 10% of the distance between the leading edge and the trailing edge measured parallel to the transverse direction;
the or each transverse portion situated between the root and 70% of the blade height extends over at most 10% of the distance between the leading edge and the trailing edge measured parallel to the transverse direction;
the number of ply drop lines on the pressure side is greater than number of ply drop lines on the suction side in a lower region of the blade between the root and 30% of the blade height and/or in an extended region of the blade between the root and 70% of the blade height; and
the number of ply drop lines on the pressure side is, over the entire blade, greater than the number of ply drop lines on the suction side.

Another object of the invention, according to a second aspect, is a turbomachine fan comprising a plurality of blades such as defined above.

Yet another object of the invention, according to a third aspect, is a turbomachine comprising such a fan.

Finally, according to a fourth aspect, an object of the invention is an aircraft comprising such a turbomachine.

### BRIEF DESCRIPTION OF THE FIGURES

Other features and advantages of the invention will appear on reading the description which follows, provided only by way of example and with reference to the attached drawings, in which:

FIG. 1 is a view from above of an aircraft according to an exemplary embodiment of the invention,

FIG. 2 is a three-quarter front perspective view of a turbomachine of the aircraft of FIG. 1,

FIG. 3 is a side view of a fan blade of the turbomachine of FIG. 2,

FIG. 4 is a simplified sectional view along a plane marked IV-IV in FIG. 3,

FIG. 5 is a three-quarter front perspective view of a structure made of composite material of the blade of FIG. 3,

FIG. 6 is a three-quarter rear perspective view of the structure made of composite material of FIG. 5,

FIG. 7 is a simplified sectional view, along a plane marked VII-VII in FIG. 6, of a portion of the structure made of composite material,

FIG. 8 is a view of a detail marked VIII in FIG. 4, and

FIG. 9 is a view of a detail marked IX in FIG. 7.

### DETAILED DESCRIPTION

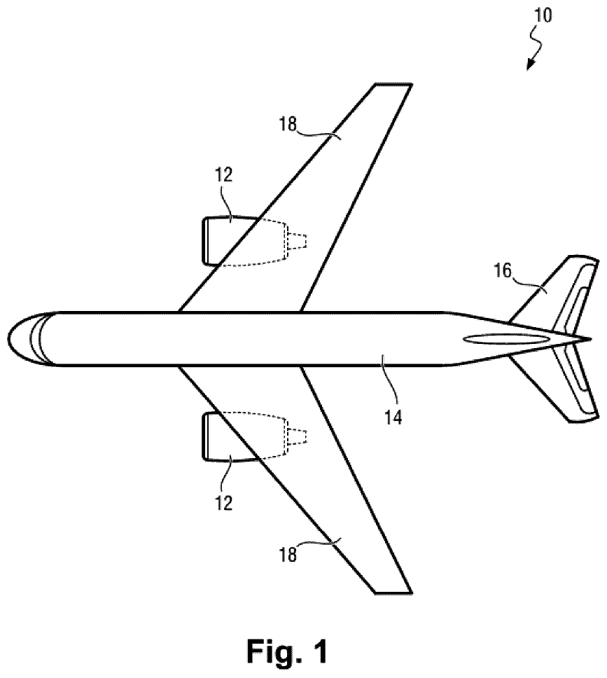

The aircraft 10 shown in FIG. 1 comprises turbomachines 12 to propel it.

In the example shown, the aircraft 10 is an aeroplane. This comprises, in conventional manner, a fuselage 14, a tail assembly 16 and two wings 18. Here, there are two turbomachines 12 each mounted under a respective wing 18. In an alternative (not shown), the turbomachines 12 are disposed along the fuselage 14, for example close to the tail assembly 16. In another alternative (also not shown), the aircraft 10 comprises a single turbomachine 12 or at least three turbomachines 12.

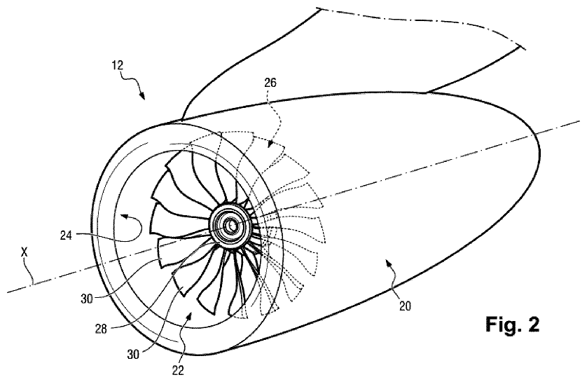

One of the turbomachines 12 is shown in FIG. 2. As can be seen in this figure, it comprises a nacelle 20 intended to be fixed to a wing 18 or to the fuselage 14 of the aircraft 10, a fan 22 and a faring 24 surrounding the fan 22. It also comprises, in conventional manner, a compressor, a combustion chamber and a turbine (not shown), the turbine being mechanically connected to the fan 22 in order to rotate it about its axis.

The turbomachine 12 is typically a turbofan engine, advantageously with high bypass flow ratio.

The faring 24 delimits the air duct. It is mounted fixed on the nacelle 20. In the illustrated example, it is disposed inside the nacelle 20. In an alternative (not shown), the turbomachine 12 has no faring.

The fan 22 comprises a fan rotor 26 able to be rotated with respect to the nacelle 20 about an axis of rotation X, which here coincides with the main axis of the turbomachine 12. The fan rotor 26 comprises a hub 28, commonly called a “fan disc”, and a plurality of blades 30 fixed to the hub 28 and extending in substantially radial directions from the hub 28. In the example shown, the blades 30 are all identical, and arranged with a constant angular distance between two successive blades 30.

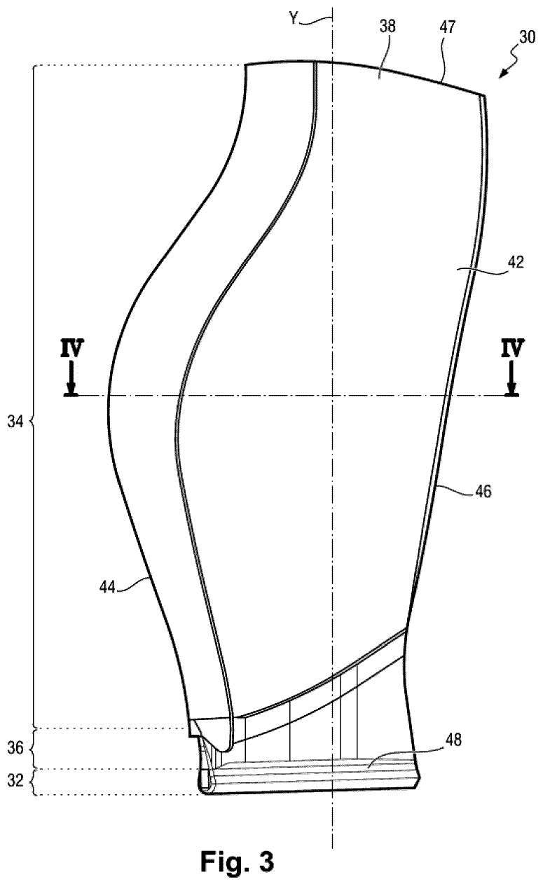

FIG. 3 schematically illustrates one of these blades 30. This blade 30 comprises a root 32, an aerofoil 34 with aerodynamic profile and a stilt 36.

The root 32 is intended to enable the fixing of the blade 30 to the hub 28, for example by means of pinned attachment (not shown). For this purpose, the root 32 is configured to be inserted in a cell (not shown) of the hub 28.

In the example shown, the root 32 is dovetail-shaped In an alternative (not shown), the root 32 has any shape suitable for enabling the assembly of the blade 30 to the hub 28. The aerofoil 34 is able to be placed in air flow when the turbomachine 12 is in operation, in order to generate lift. At its opposite end to the root 32, it defines a blade tip 38.

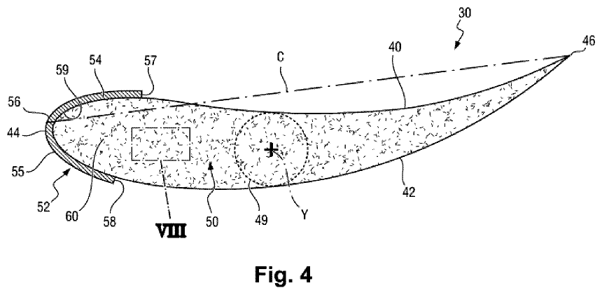

Furthermore, the aerofoil 34 has a pressure side 40 (FIG. 4), a suction side 42, a leading edge 44 and a trailing edge 46.

The aerofoil 34 also has a blade tip edge 47, constituted by the free edge of the blade 30 furthest away from the root 32. The blade tip edge 47 is able to extend along an inner surface of the faring 24 surrounding the fan.

The stilt 36 corresponds to the area of the blade 30 which extends between the root 32 and the aerofoil 34, in other words between the exit of the bearings 48 and the inter-blade platforms (not shown) which internally delimit the secondary flow duct. The stilt 36 it is therefore not configured for extending in an air flow.

The blade 30 is elongated along a longitudinal axis Y orthogonal to the axis X and extending from the root 32 to the tip 38. The longitudinal axis Y is also orthogonal to a chord direction C (FIG. 4) connecting the leading edge 44 to the trailing edge 46.

Here and in the following, the term “blade height” shall mean a distance measured along the axis Y between a point of the blade 30 and the exit of the bearings 48. This distance is most often expressed in a dimensionless manner, in percent of the distance from the edge of the tip 47 to the exit of the bearings 48.

As can be seen in FIG. 4, the blade 30 has a blade core 49 at which the thickness of the blade 30 following the chord direction C is maximum. In other words, the thickness of the blade 30 will decrease from the blade core 49 towards each of the leading edge 44 and trailing edge 46. The blade core 49 is, in particular, centred on the longitudinal axis Y.

In the example shown, the blade 30 is twisted around the blade core 49, so that the chord C pivots around the longitudinal axis Y as a function of the blade height.

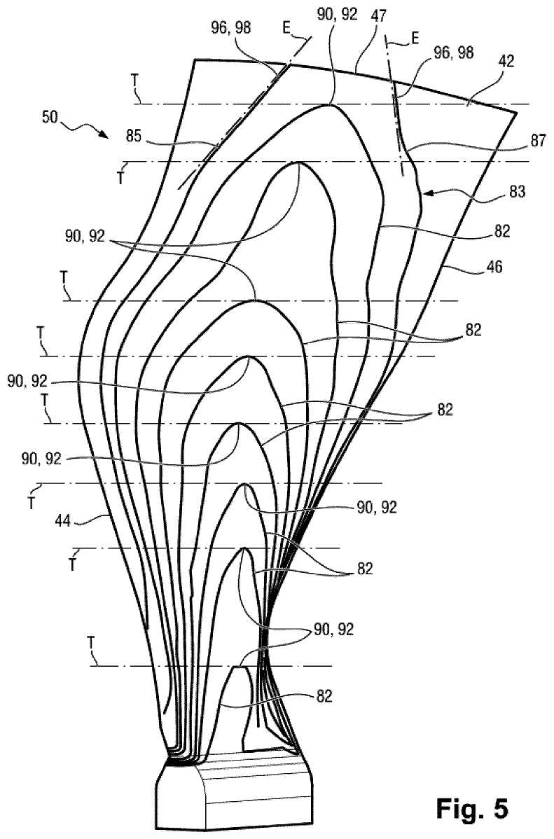

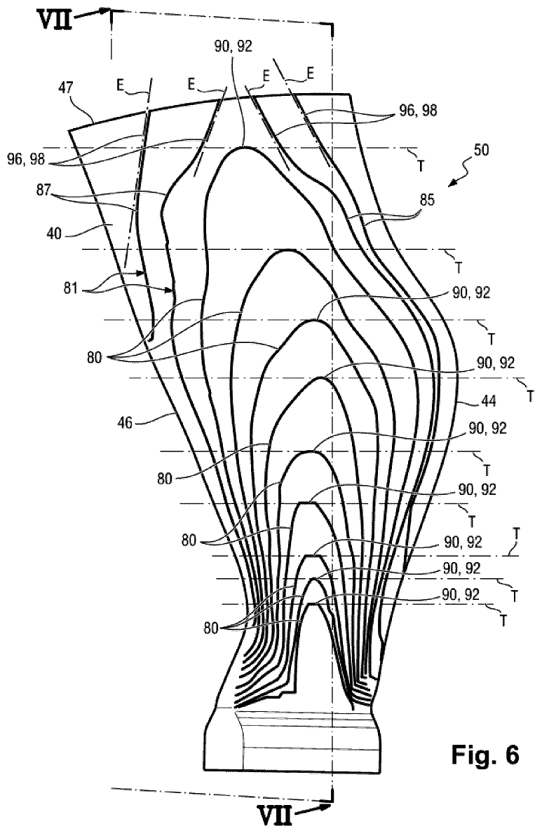

With reference to FIG. 4, here the blade 30 is composed of a structure 50 made of composite material. As can be seen in FIGS. 5 and 6, this structure 50 extends here in the longitudinal axis Y from the root 32 to the tip 38, in the chord direction C from the leading edge 44 to the trailing edge 46, and along the thickness of the blade 30 from the pressure side 40 to the suction side 42. In particular, the structure 50 substantially matches the shape of the blade 30. Optionally, it defines, at least in part, the outer surface of the blade 30.

Due to this proximity of shapes between the blade 30 and the structure 50, here the same terms will be used to designate both surface regions of the blade 30 and the elements of the structure 50 relating thereto. Thus, the term “pressure side 40” designates both the pressure side of the blade 30 itself, but also the face of the structure 50 on the pressure side, even though this face does not directly define the pressure side of the blade 30 (in other words even if the face of the structure 50 on the pressure side is covered by another element). Similarly, the term “suction side 42” designates both the suction side of the blade 30 itself, but also the face of the structure 50 on the suction side, even though this face does not directly define the suction side of the blade 30 (in other words even if the face of the structure 50 on the suction side is covered by another element).

The structure 50 is commonly called the “body” of the blade 30.

Still with reference to FIG. 4, here the blade 30 is also composed of an added shield 52 covering the composite structure 50 along the leading edge 44. This shield 52 is formed of two fins 54, 55 connected together at the apex 56 of the shield 52. A first fin 54, disposed on the pressure side 40, defines a downstream edge on the pressure side 57 of the shield 52. The second fin 55, disposed on the suction side 42, defines a downstream edge on the suction side 58 of the shield 52.

The two fins 54, 55 together define a cavity 59 in which an upstream end 60 of the structure 50 is housed.

The shield 52 is typically made of a metal foil.

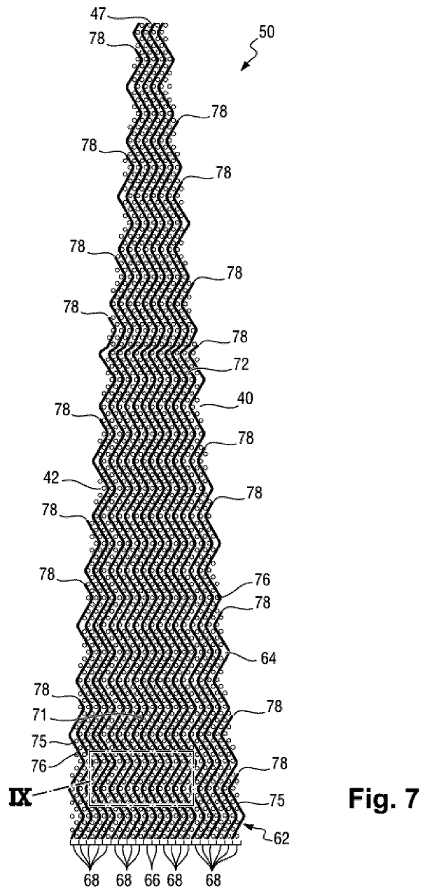

With reference to FIG. 7, the structure 50 comprises a fibrous reinforcement 62 and a matrix 64 in which the fibrous reinforcement 62 is embedded.

The fibrous reinforcement 62 comprises a plurality of interwoven plies 66, 68, stacked along the thickness of the blade 30, in other words along the direction going from the pressure side 40 to the suction side 42.

Each ply 66, 68 is formed of warp strands 71 and weft strands 72. Each warp strand 71 extends from the root 32 towards the tip 38, substantially orthogonally to the chord direction C. Each weft strand 72 extends from the blade core 49 towards each of the leading edge 44 and trailing edge 46, substantially orthogonally to the longitudinal axis Y.

The term “substantially orthogonally” shall be understood here and in the following as that the strands 70, 72 form an angle between 85 and 95° with the direction or the axis in question (here respectively the chord direction C and the longitudinal axis Y).

The fibrous reinforcement 52 is obtained by three-dimensional weaving, in other words at least some of the warp strands 71 belonging to a ply 66, 68 bind weft strands 72 belonging to another ply 66, 68. Three-dimensional weaving techniques are described, for example, in WO 2006/136755.

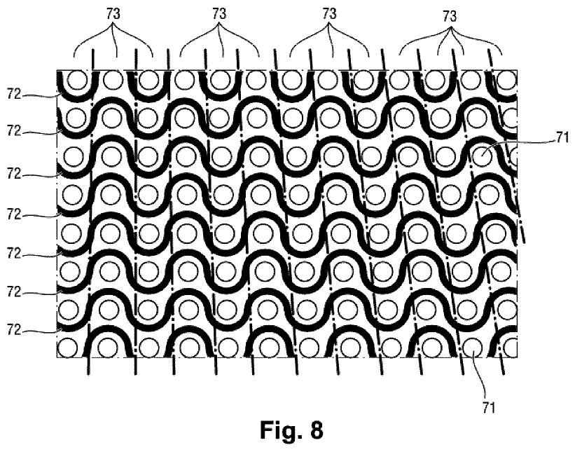

As can be seen in FIG. 8, the warp strands 71 are arranged in warp columns 73 each formed by the juxtaposition, along the thickness of the blade 30, of warp strands 71 from different plies 66, 68. Thus, each warp column 73 extends along the surface roughly orthogonal to the chord direction C.

Each warp strand 71 belongs to only one warp column 73.

Each warp column 73 is substantially parallel to its neighbours. In other words, for each blade height, the normal to each warp column 73 forms an angle less than or equal to 5° with the normal to each of its neighbours.

The view of FIG. 7 corresponds to a section in a warp column 73. FIG. 7 thus illustrates one of the many planes which repeat along the chord direction C between the leading edge 44 and the trailing edge 46. The other planes are similar to the illustrated plane, except that the warp strands 71 are offset in the longitudinal direction such that the warp strands 71 and the weft strands 72 are connected at different heights according to the planes.

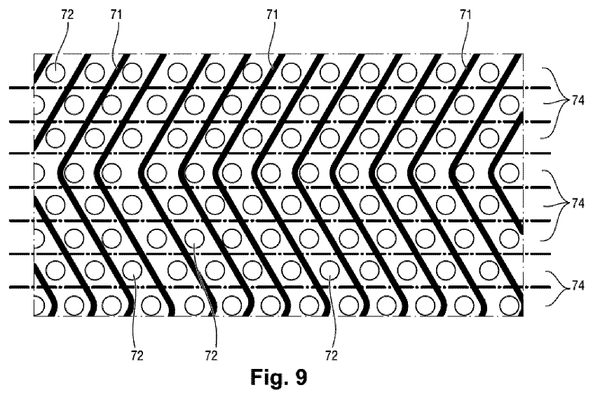

As can be seen in FIG. 9, the weft strands 72 are arranged in weft columns 74 each formed by the juxtaposition, along the thickness of the blade 30, of weft strands 72 from different plies 66, 68. Thus, each weft column 74 extends along the surface roughly orthogonal to the longitudinal axis Y.

Each weft strand 72 belongs to only one weft column 74

Each weft column 74 is substantially parallel to its neighbours. In other words, the normal to each weft column 74 forms an angle less than or equal to 5° with the normal to each of its neighbours.

Furthermore, each weft column 74 is substantially orthogonal to each warp column 73, in other words, for each weft column 74-warp column 73 pair, the average normal to the weft column 74 is substantially orthogonal to the average normal to the warp column 73.

Returning to FIG. 7, the plies 66, 68 comprise at least one entire ply 66, for which each of the warp strands 71 extends from the root 32 to the tip 38 and each of the weft strands 72 extends from the leading edge 44 to the trailing edge 46, and partial plies 68 comprising incomplete warp strands 75 and/or incomplete weft strands 76. The incomplete warp strands 75 are constituted by warp strands 71 interrupted at the surface of the structure 50, before the tip 38, in order to enable a reduction in the thickness of the blade 30 along the longitudinal axis Y. The incomplete weft strands 76 are constituted by weft strands 72 interrupted at the surface of the structure 50, before the leading edge 44 and/or the trailing edge 46, in order to enable a reduction in the thickness of the blade 30 along the chord direction C.

It will be noted that a first strand 71,72 which, although interrupted on the pressure side 40 or on the suction side 42, is extended by a second strand 71, 72 substantially starting where the first strand 71, 72 ends, is not considered to constitute an incomplete strand 75, 76.

Each incomplete strand 75, 76 has at least one terminal end 78 on the pressure side 40 or on the suction side 42. The terminal ends 78 of the incomplete strands 75, 76 of a same ply 68 are spaced apart two-by-two by a distance on the order of the mesh width of the fibrous reinforcement 62.

Here and in the following, the term “mesh width of the fibrous reinforcement 62” shall mean the average of, on the one hand, the average distance between the warp columns 73 and, on the other hand, the average distance between the weft columns 74.

For each partial ply 68, the terminal ends 78 of the incomplete strands 75, 76 composing them are connected to one another by a respective ply drop line 80, 81, 82, 83 (FIGS. 5 and 6) present on the pressure side 40 or on the suction side 42. This ply drop line 80, 81, 82, 83 is constituted by a curve of at least class C¹ (or by a set of two curves each of at least class C¹) running through the pressure side 40 and the suction side 42 respectively.

Each ply drop line 80, 81, 82, 83 forms a boundary between two regions of the blade (not given a reference sign): an inner region extending between the ply drop line 80, 81, 82, 83 and the root 32 and an outer region extending between the ply drop line 80, 81, 82, 83 and each of the leading edge 44, trailing edge 46 and tip edge 47. The inner region has, at each point, a number of strands 71, 72 stacked along the thickness of the blade 30, greater than or equal to a first value. The outer region has, at each point, a number of strands 71, 72 stacked along the thickness of the blade 30, less than or equal to a second value strictly less than the first value. In other words, the number of strands 71, 72 stacked along the thickness of the blade 30 is lower in the outer region than in the inner region.

Here, the number of ply drop lines 80, 81 on the pressure side 40 is greater than the number of ply drop lines 82, 83 on the suction side 42 in a lower region of the blade 30 extending from the root 32 up to 30% of the blade height. This numerical superiority of ply drop lines 80, 81 on the pressure side 40 over the ply drop lines 82, 83 on the suction side 42 is observed again in an extended region of the blade 30 extending from the root 32 up to 70% of the blade height and even over the entire blade 30. In an alternative (not shown), the numerical superiority of ply drop lines 80, 81 on the pressure side 40 over the ply drop lines 82, 83 on the suction side 42 is only observed in the lower region of the blade 30 (in other words, the number of ply drop lines 80, 81 on the pressure side 40 is less than the number of ply drop lines 82, 83 on the suction side 42 in an intermediate region of the blade extending from 30% of the blade height to 70% of the blade height) or only in the lower and extended regions of the blade 30 (in other words, the number of ply drop lines 80, 81 30 on the pressure side 40 is less than the number of ply drop lines 82, 83 on the suction side 42 in the region extending beyond 70% of the blade height). In another alternative (still not shown), the numerical superiority of ply drop lines 80, 81 on the pressure side 40 over the ply drop lines 82, 83 on the suction side 42 is observed in the extended region of the blade 30, but not in the lower region (in other words, the number of ply drop lines 80, 81 on the pressure side 40 is less than or equal to the number of ply drop lines 82, 83 on the suction side 42 in the lower region of the blade 30 and greater than the number of ply drop lines 82, 83 on the suction side 42 in the intermediate region).

This feature gives the blade 30 an improved resistance to “large bird” impacts.

As can be seen in FIGS. 5 and 6, the ply drop lines 80, 81, 82, 83 include continuous ply drop lines 80, 82 and discontinuous ply drop lines 81, 83. Each continuous ply drop line 80, 82 is constituted by a single curve of at least class C¹ running through the pressure side 40 and the suction side 42 respectively, from the leading edge 44 to the trailing edge 46. Each discontinuous ply drop line 81, 83 comprises a first segment 85 constituted of a curve of at least class C¹ running through the pressure side 40 and the suction side 42 respectively, from the leading edge 44 to the tip edge 47, and a second segment 87 constituted of a curve of at least class C¹ running through the pressure side 40 and the suction side 42 respectively, from the tip edge 47 to the trailing edge 46.

Each continuous ply drop line 80, 82 has an apex (not given a reference sign), constituted by the point of the ply drop line 80, 82 furthest away from the root 32.

Each continuous ply drop line 80, 82 includes at least one transverse portion 90 extending overall in a transverse direction T, substantially orthogonal to the local tangent to the warp strands 71. In other words, for each of the incomplete warp strands 75 opening on the transverse portion 90, the transverse direction T is substantially orthogonal to the plane locally tangent to the warp column 73 to which said incomplete warp strands 75 belong, in other words to the plane tangent to said warp column 73 at the terminal end 78 of the incomplete warp strand 75.

Here and in the following, the term “extends overall in a direction” shall mean that the element in question (here the transverse portion 90) is included in a strip centred on said direction and of width equal to four times the mesh width of the fibrous reinforcement 62. In other words, said direction constitutes a median of the element in question and each point of said element is remote from said direction by a distance less than or equal to twice the mesh width of the fibrous reinforcement 62.

Here and in the following, the term “substantially orthogonal” shall mean that the directions in question form an angle of between 85 and 95° between them.

The transverse direction T is furthermore substantially parallel to the local tangent to the weft strands 72. In other words, each of the weft strands 72 flush with the pressure side 40 or the suction side 42 along the transverse direction T, is substantially parallel to said transverse direction T over the entire extension of the transverse portion 90.

Here and in the following, the term “substantially parallel” shall mean that the directions in question form an angle of less than 5° between them.

A transverse portion 90 of each continuous ply drop line 80, 82 is constituted by an apex portion 92 including the apex of said ply drop line 80, 82. Each apex portion 92 situated between the root 32 and 70% of the blade height extends over at most 10% of the distance between the leading edge 44 and the trailing edge 46 measured parallel to the transverse direction T.

In general, each transverse portion 90 situated between the root 32 and 70% of the blade height extends over at most 10% of the distance between the leading edge 44 and the trailing edge 46 measured parallel to the respective transverse direction 90 of said transverse portion.

This management of the drop locations of strands 71, 72 enables their robustness to be optimised. Thus, the resistance of the blade 30 to “large bird” impacts is reinforced.

Each discontinuous ply drop line 81, 83 comprises at least one terminal portion 96 which extends from the blade tip 38, in particular from the tip edge 47, up to 90% of the blade height, advantageously 60% of the blade height.

This terminal portion 96 extends overall in a direction of extension E forming an angle between 5° and 85° with the local tangent to the warp strands 71. In other words, for each of the incomplete warp strands 75 opening on the terminal portion 96, the extension direction E forms an angle between 5° and 85° with the plane locally tangent to the warp column 73 to which said incomplete warp strands 75 belong, in other words with the plane tangent to said warp column 73 at the terminal end 78 of the incomplete warp strand 75.

The extension direction E also forms an angle between 5° and 85° with the local tangent to the weft strands 72. In other words, for each of the incomplete weft strands 76 opening on the terminal portion 96, the extension direction E forms an angle between 5° and 85° with the plane locally tangent to the weft column 74 to which said incomplete weft strand 76 belongs, in other words with the plane tangent to said weft column 74 at the terminal end 78 of the incomplete weft strand 76.

Each terminal portion 96 on the pressure side 40 also fulfils at least one of the following criteria at each of its points:
the terminal portion 96 is spaced apart from the downstream edge on the pressure side 57 of the shield 52 by a distance greater than or equal to three times the mesh width of the fibrous reinforcement 62, and
the tangent to the terminal portion 96 forms an angle greater than or equal to 5°, advantageously greater than or equal to 15°, with the tangent to said downstream edge on the pressure side 57 at the height of said point.

In other words, for any section of a terminal portion 96 on the pressure side 40 distant from the downstream edge on the pressure side 57 of the shield 52 by a distance less than three times the mesh width of the fibrous reinforcement 62, the tangent to the terminal portion 96 at each point of said section forms an angle greater than or equal to 5°, advantageously greater than or equal to 15°, with the tangent to said downstream edge on the pressure side 57 at the height of said point.

Each terminal portion 96 on the suction side 42 also fulfils at least one of the following criteria at each of its points:
the terminal portion 96 is spaced apart from the downstream edge on the suction side 58 of the shield 52 by a distance greater than or equal to three times the mesh width of the fibrous reinforcement 62, and
the tangent to the terminal portion 96 forms an angle greater than or equal to 5°, advantageously greater than or equal to 15°, with the tangent to said downstream edge on the suction side 58 at the height of said point.

In other words, for any section of a terminal portion 96 on the suction side 42 distant from the downstream edge on the suction side 58 of the shield 52 by a distance less than three times the mesh width of the fibrous reinforcement 62, the tangent to the terminal portion 96 at each point of said section forms an angle greater than or equal to 5°, advantageously greater than or equal to 15°, with the tangent to said downstream edge on the suction side 58 at the height of said point.

A majority of said terminal portions 96, and here all of the terminal portions 96, are constituted by inclined terminal portions 98, the extension direction E of which forms an angle between 10° and 65°, advantageously between 15° and 45°, with the local tangent to the warp strands 71. In other words, for each of the incomplete warp strands 75 opening on an inclined terminal portion 98, the extension direction E of said inclined terminal portion 98 forms an angle between 10° and 65°, advantageously between 15° and 45°, with the plane locally tangent to the warp column 73 to which said incomplete warp strand 75 belongs, in other words with the plane tangent to said warp column 73 at the terminal end 78 of the incomplete warp strand 75.

For each inclined terminal portion 98, the extension direction E also forms an angle between 25° and 80°, advantageously between 45° and 75°, with the local tangent to the weft strands 72. In other words, for each of the incomplete weft strands 76 opening on the inclined terminal portion 98, the extension direction E of said inclined terminal portion 98 forms an angle between 25° and 80°, advantageously between 45° and 75°, with the plane locally tangent to the weft column 74 to which said incomplete weft strand 76 belongs, in other words with the plane tangent to said weft column 74 at the terminal end 78 of the incomplete weft strand 76.

These features give the blade 30 a reinforced resistance to “small bird” impacts.

Through the features of the embodiment described above, the mechanical behaviour of a composite structure blade in the event of an impact with a bird or hailstones is improved. This makes it possible to have a thinner blade while maintaining a constant strength, and thus saving weight and gaining aerodynamic performance.

1. A turbomachine fan blade comprising a root configured to be attached to a fan disc and an aerofoil able to extend in an air flow and defining a blade tip opposite the root, the blade having a pressure side, a suction side, a leading edge and a trailing edge, the blade being elongated in a longitudinal direction going from the root to the blade tip, said longitudinal direction being substantially orthogonal to a chord direction going from the leading edge to the trailing edge, the blade being composed at least in part of a structure made of composite material comprising a fibrous reinforcement obtained by three-dimensional weaving and a matrix in which the fibrous reinforcement is embedded, the fibrous reinforcement comprising a plurality of interwoven plies, each ply being formed of warp strands extending substantially orthogonally to the chord direction and weft strands extending substantially orthogonally to the longitudinal direction, the warp strands and the weft strands including incomplete strands each having a terminal end on the pressure side or on the suction side, the pressure side and the suction side each having at least one ply drop line each connecting the terminal ends of the incomplete strands of a same ply,
wherein at least one ply drop line comprises a terminal portion which extends from the blade tip to 90% of a height of the blade, the or each terminal portion extending overall in an extension direction forming an angle between 5° and 85° with a local tangent to the warp strands.

2. The blade of claim 1, wherein, for the or each terminal portion, the extension direction forms an angle between 5° and 85° with a local tangent to the weft strands.

3. The blade of claim 1, wherein at least one terminal portion is constituted by an inclined terminal portion, the extension direction of which forms an angle between 10° and 65° with the local tangent to the warp strands.

4. The blade of claim 3, wherein, for the or each inclined terminal portion, the extension direction forms an angle between 25° and 80° with a local tangent to the weft strands.

5. The blade of claim 3, wherein a majority of the terminal portions are constituted by inclined terminal portions.

6. The blade of claim 1, comprising an added shield covering the composite structure along the leading edge, the shield having a downstream edge on the pressure side and a downstream edge on the suction side, the or each terminal portion on the pressure side fulfilling at least one of the following criteria at each of its points:
the terminal portion is spaced apart from the downstream edge on the pressure side by a distance greater than or equal to three times a mesh width of the fibrous reinforcement, and
a tangent to the terminal portion forms an angle greater than or equal to 5° with a tangent to the downstream edge on the pressure side at the height of said point,
and the or each terminal portion on the suction side fulfilling at least one of the following criteria at each of its points:
the terminal portion is spaced apart from the downstream edge on the suction side by a distance greater than or equal to three times the mesh width of the fibrous reinforcement, and
a tangent to the terminal portion forms an angle greater than or equal to 5° with a tangent to the downstream edge on the suction side at the height of said point.

7. The blade of claim 1, wherein at least one ply drop line includes at least one transverse portion situated between the root and 70% of the height of the blade, including an apex portion, the or each transverse portion extending overall in a transverse direction substantially orthogonal to the local tangent to the warp strands, the or each apex portion extending over at most 10% of a distance between the leading edge and the trailing edge measured parallel to the transverse direction.

8. The blade of claim 7, wherein the or each transverse portion situated between the root and 70% of the height of the blade extends over at most 10% of the distance between the leading edge and the trailing edge measured parallel to the transverse direction.

9. The blade according of claim 1, wherein the ply drop lines are in greater number on the pressure side than on the suction side in a lower region of the blade between the root and 30% of the height of the blade and/or in an extended region of the blade between the root and 70% of the height of the blade.

10. The blade of claim 1, wherein the ply drop lines are, over the entire blade, in greater number on the pressure side than on the suction side.

11. The blade of claim 1, wherein the root is configured to be inserted in a cell of a fan disc, the blade also comprising a stilt connecting the root to the aerofoil.

12. A turbomachine fan comprising a plurality of the blades of claim 1.

13. A turbomachine comprising the fan of claim 12.

14. An aircraft comprising the turbomachine of claim 13.
